(19) United States
(12) Patent Application Publication
(10) Pub. No.: US 2025/0273694 A1
(43) Pub. Date: Aug. 28, 2025

(54) CURRENT COLLECTING IN METAL-AIR BATTERIES

(71) Applicant: Form Energy, Inc., Somerville, MA (US)

(72) Inventor: Derek PAXSON, Boston, MA (US)

(21) Appl. No.: 19/060,931

(22) Filed: Feb. 24, 2025

Related U.S. Application Data
(60) Provisional application No. 63/556,625, filed on Feb. 22, 2024.

(51) Int. Cl. H01M 4/74; H01M 12/08

(52) U.S. Cl. CPC H01M 4/742; H01M 12/08

(57) ABSTRACT

The present disclosure is generally directed to current collectors for electrochemical cells and methods of fabricating current collectors. In some implementations, a current collector includes a terminal electrically connectable to an external electric circuit. The current collector includes a substrate including an electrically conductive material and having a first end portion and a second end portion. The terminal is disposed on the first end portion. The substrate has a length from the first end portion to the second end portion. The electrically conductive material has a cross-sectional area decreasing along at least a portion of the length in a longitudinal direction from the terminal to the second end portion of the substrate.

### CROSS-REFERENCE TO RELATED APPLICATIONS

This application claims the benefit of priority to U.S. Provisional Patent Application 63/556,625, filed Feb. 22, 2024, the entire contents of which are hereby incorporated herein by reference.

### BACKGROUND

Energy storage technologies are playing an increasingly important role in electric power grids. These energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultralong (collectively, >8 h) energy storage systems. Of benefit are potentially low-cost rechargeable battery chemistries that can enable long duration large scale energy storage.

### SUMMARY

According to an aspect, a current collector for an electrochemical cell may include: a terminal electrically connectable to an external electric circuit; and a substrate including an electrically conductive material and having a first end portion and a second end portion, the terminal disposed on the first end portion, the substrate having a length from the first end portion to the second end portion, and the electrically conductive material having cross-sectional area decreasing along at least a portion of the length in a longitudinal direction from the terminal to the second end portion of the substrate.

In certain implementations, the substrate may have a span and a thickness perpendicular to one another and each perpendicular to the length, and the thickness is less than each of the length and the span at any point along the substrate. As an example, the substrate may have a first electrical conductivity parallel to the length of the substrate, the substrate has a second electrical conductivity parallel to the span of the substrate, and the first electrical conductivity is greater than the second electrical conductivity. Further, or instead, the span of the substrate may vary in the longitudinal direction from the terminal to the second end portion of the substrate. In certain implementations, the span of the substrate may have a minimum at the first end portion of the substrate and a maximum away from the first end portion of the substrate. Further, or instead, the length may have a maximum dimension of the substrate. The substrate may define a plurality of openings extending parallel to the thickness of the substrate. As an example, the substrate may be a sheet. In some instances, one or more of the plurality of openings may have a maximum dimension parallel to the length of the substrate. Further, or instead, one or more of the plurality of openings may have at least one straight edge. Still further, or instead, one or more of the plurality of openings may have at least one curved edge. In certain instances, the plurality of openings may include a first set of openings and a second set of openings, the first set of openings collectively having a first open area in a plane defined by the length and the span of the substrate, the second set of openings collectively having a second open area in the plane defined by the length and the span of the substrate, the second open area is greater than the second open area, and at least a portion of one or more of the first set of openings is disposed between the first end portion and at least a portion of one or more of the second set of openings in the longitudinal direction from the terminal to the second end portion. The first set of openings include at least one elongated hexagon in a plane defined by the length and the span of the substrate. A maximum dimension of the elongated hexagon may be parallel to the length of the substrate. The second set of openings may include at least one square-shape in a plane defined by the length and span of the substrate. Further, or instead, the first set of openings, the second set of openings, or both may include at least one diamond-shaped opening in a plane defined by the length and the span of the substrate. In some instances, at least one of the first set of openings may have a first width parallel to the span of the substrate, at least one of the second set of openings has a second width parallel to the span of the substrate, and the second width is greater than the first width. In certain instances, at least one of the first set of openings may have a first length dimension parallel to the length of the substrate, at least one of the second set of openings has a second length dimension parallel to the length of the substrate, and the second length dimension is greater than the first length dimension. In some instances, the plurality of openings may include a third set of openings collectively having a third open area greater than the first open area and less than the second open area, and at least a portion of one or more of the third set of openings is disposed between at least a portion of one or more of the first set of openings and at least a portion of one or more of the second set of openings along the length of the substrate. In some instances, the plurality of openings may be longitudinally spaced away from the first end portion of the substrate such that the first end portion of the substrate is along the span of the first end portion of the substrate.

According to another aspect, a method of fabricating a current collector for an electrochemical cell may include: perforating a feedstock of electrically conductive material; applying force along perforations of the electrically conductive material, the force forming a substrate of the electrically conductive material with the substrate expanding the perforations into a plurality of openings from a first end portion of the substrate to a second end portion of the substrate, and the electrically conductive material having cross-sectional area decreasing along at least a portion of the substrate in a longitudinal direction from the first end portion to the second end portion of the substrate; and mounting a terminal to the first end portion of the substrate.

According to yet another aspect, an electrochemical cell may include a pair of electrodes spaced apart from one another; an electrolyte infiltrated into each one of the pair of electrodes; and the current collector of any one or more of the preceding aspects in contact with one electrode of the pair of electrodes.

According to still another aspect, a current collector for an electrochemical cell may include: a terminal electrically connectable to an external electric circuit; and a substrate of an electrically conductive material, the substrate having a first end portion and a second end portion, the terminal coupled to the first end portion, the first end portion and the second end portion defining a length of the substrate perpendicular to a thickness of the substrate, the substrate defining a plurality of non-circular openings through the thickness, a shape of each non-circular opening on a surface of the substrate having a maximum dimension defining a respective major axis, and the respective major axis of each non-circular opening oblique to the length of the substrate.

In some implementations, each non-circular opening may have a minimum dimension defining a respective minor axis, the minimum dimension is less than the major dimension, and the minor axis of each non-circular opening is oblique to the length of the substrate.

In certain implementations, the substrate may have an average thickness greater than 0.35 mm and less than 0.55 mm.

In some implementations, collectively, the plurality of non-circular openings may have a total open area that is 40 percent of a total overall area of the substrate.

### DESCRIPTION OF THE DRAWINGS

FIG. 1A is a schematic representation of an electrochemical cell.

FIG. 1B is a schematic representation of a rechargeable battery.

FIG. 2A is a front view of a current collector of an electrochemical cell.

FIG. 2B is a side view of a substrate of the current collector of FIG. 2A.

FIG. 2C is a cross-sectional side view of the substrate of FIG. 2B, with the cross-section taken along A-A in FIG. 2A.

FIG. 3 is a front view of a current collector including a substrate that is an expanded mesh.

FIG. 4 is a flow chart of an exemplary method for fabricating a current collector for an electrochemical cell.

FIG. 5A is a front view of a current collector including a plurality of openings oblique to a length and to a span of a substrate of the current collector.

FIG. 5B is a close-up view of the area of detail 5B in FIG. 5A.

Like reference symbols in the various drawings indicate like elements.

### DETAILED DESCRIPTION

Embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the disclosure is not intended to limit the disclosure to these embodiments but rather to enable a person skilled in the art to make and use this disclosure. Unless otherwise noted, the accompanying drawings are not drawn to scale.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present disclosure. These examples are for illustrative purposes, may be prophetic, and should not be viewed as limiting, and do not otherwise limit the scope of the present disclosure.

The various embodiments of systems, equipment, techniques, methods, activities, and operations set forth in this specification may be used for various other activities and in other fields in addition to those set forth herein. Additionally, these embodiments, for example, may be used with other equipment or activities that may be developed in the future and with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other. Accordingly, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. The scope of protection afforded the present disclosure should not be limited to a particular embodiment, configuration or arrangement that is set forth in a particular embodiment, example, or in an embodiment in a particular figure.

Unless expressly stated otherwise all tests, test results, physical properties, and values that are temperature dependent, pressure dependent, or both, are provided at standard ambient temperature and pressure.

Embodiments of the present disclosure include apparatuses, systems, and methods for long-duration, and ultra-long-duration energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage devices or systems may refer to energy storage devices or systems that may be configured to store energy over time spans of days, weeks, or seasons. For example, the energy storage devices or systems may be configured to store energy generated by solar cells during the summer months, when sunshine is plentiful and solar power generation exceeds power grid requirements, and discharge the stored energy during the winter months, when sunshine may be insufficient to satisfy power grid requirements.

According to other embodiments, the present disclosure includes apparatus, systems, and methods for energy storage at shorter durations of less than about 8 hours. For example, the electrochemical cells may be configured to store energy generated by solar cells during the diurnal cycle, where the solar power generation in the middle of the day may exceed power grid requirements, and discharge the stored energy during the evening hours, when the sunshine may be insufficient to satisfy power grid requirements. As another example, apparatus, systems, and methods of the present disclosure may include energy storage used as backup power when the electricity supplied by the power grid is insufficient, for installations including homes, commercial buildings, factories, hospitals, or data centers, where the required discharge duration may vary from a few minutes to several days.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal resistive elements in series. Generally, the external element conducts electrons, and the internal element (electrolyte) conducts ions. Because a charge imbalance cannot be sustained between the negative electrode and positive electrode, these two flow streams supply ions and electrons at the same rate. In operation, the electronic current can be used to drive an external device. A rechargeable battery can be recharged by applying an opposing voltage difference that drives an electric current and ionic current flowing in the opposite direction as that of a discharging battery in service.

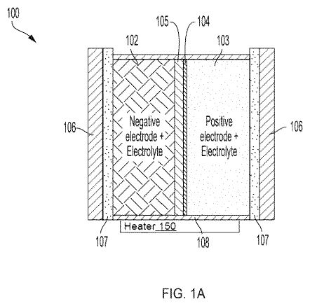

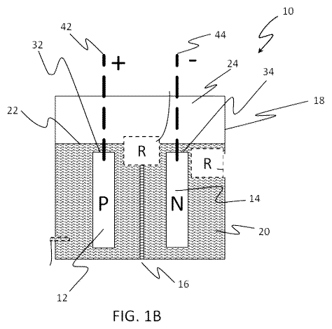

Referring now to FIG. 1A, an electrochemical cell 100 (e.g., a battery) may include a negative electrode 102 separated from a positive electrode 103 by a separator 104. The separator 104 may be supported, for example, by a mesh 105 (e.g., a polypropylene mesh) and a frame 108 (e.g., polyethylene or polypropylene) of the electrochemical cell 100. Current collectors 107 may be associated with respective ones of the negative electrode 102 and with respective ones of the positive electrode 103 and supported by backing plates 106 (e.g., polyethylene or polypropylene backing plates). In some embodiments, the temperature of the electrochemical cell 100, may be controlled, such as by insulation around the electrochemical cell 100 and/or by a heater 150. For example, the heater 150 may raise the temperature of the electrochemical cell 100 and/or specific components of the cell (e.g., an electrolyte infiltrated in the negative electrode 102 and the positive electrode 103). The electrolyte may be an aqueous solution. In certain embodiments the electrolyte may be an alkaline solution (pH>10). In certain embodiments, the electrolyte may be a near-neutral solution (10>pH>4).

The electrochemical cell 100 is an example of one electrochemical cell configuration according to various embodiments and is not intended to be limiting. Other configurations, such as electrochemical cells with different type meshes and/or without the mesh 105, electrochemical cells with different type frames and/or without the frame 108, electrochemical cells with different type current collectors and/or without the current collectors 107, electrochemical cells with reservoir structures, electrochemical cells with different type backing plates and/or without the backing plates 106, electrochemical cells with different type insulation and/or without insulation, and/or electrochemical cells with different type heaters and/or without the heater 150, may be substituted for the example configuration of the electrochemical cell 100 shown in FIG. 1A and other configurations are in accordance with the various embodiments described herein, unless expressly indicated or made clear from the context.

In some embodiments, a plurality of instances of the electrochemical cell 100 may be connected electrically in series to form a stack. In certain other embodiments, a plurality of instances of the electrochemical cell 100 may be connected electrically in parallel. In certain other embodiments, a plurality of instances of the electrochemical cell 100 are connected in a mixed series-parallel electrical configuration to achieve a favorable combination of delivered current and voltage.

Referring now to FIG. 1B, a rechargeable battery 10 may include a positive electrode 12, a negative electrode 14, and a separator 16 within a container 18 filled with electrolyte 20 to a level 22 at least as high as a top 32 of the positive electrode 12 and a top 34 of the negative electrode 14. The space above the level 22 of the electrolyte 20 may be referred to as a headspace 24. The positive electrode 12 may be electrically connected to a positive terminal 42 of the rechargeable battery 10 and may contain active material that may undergo reduction reactions during discharging and oxidation reactions during charging of the rechargeable battery 10. The negative electrode 14 may be electrically connected to a negative terminal 44 of the rechargeable battery 10 and may contain active material that may undergo oxidation reactions during discharging and reduction reactions during charging of the rechargeable battery 10. The rechargeable battery 10 is an example of one electrochemical cell according to various embodiments and is not intended to be limiting.

In various embodiments, the electrolyte 20 may be an aqueous or non-aqueous alkaline, neutral, or acidic solution. For example, the electrolyte solution may contain potassium hydroxide (KOH), sodium hydroxide (NaOH), lithium hydroxide (LiOH) or combinations of these.

In some embodiments, a rechargeable battery 10 may include a separator 16 that allows transfer of ions between the positive electrode 12 and the negative electrode 14 via the electrolyte 20. In some embodiments, the separator 16 may be chosen based on an ability to allow selective transfer of desired molecules or materials while substantially limiting or preventing transfer of undesired molecules or materials. For example, the separator 16 may be an ion-selective membrane that allows the transfer of negative (or positive) ions while substantially preventing transfer of positive (or negative) ions. In other examples, materials for the separator 16 may be chosen based on an ability to allow, restrict, or prevent the cross-over of gas bubbles from one side (associated with one electrode) to the opposite side (associated with the counter-electrode).

In various embodiments, the container 18 may be made of any suitable materials and construction capable of containing the electrolyte 20, the positive electrode 12, the negative electrode 14, and at least a minimum amount of gas pressure. For example, the container 18 may be made of metals, plastics, composite materials, or others. In some embodiments, the container 18 may be sealed to prevent, or at least limit, the escape of one or more gases generated during operation of the rechargeable battery 10.

In some embodiments, the container 18 may include a pressure relief valve to allow release of gases when a gas pressure within the container 18 exceeds a pre-determined threshold.

While the positive electrode 12 and the negative electrode 14 are shown substantially spaced apart in the figures, in some embodiments the electrodes may be close to one another or even compressed against one another with the separator 16 in between. Furthermore, although the figures illustrate a single instance of the positive electrode 12 and a single instance of the negative electrode 14, battery systems within the scope of the present disclosure may also include two or more instances of the positive electrode 12 and/or two or more instances of the negative electrode 14.

Referring now to FIGS. 1A and 1B, it shall be generally understood that the negative electrode 102 of the electrochemical cell 100 and/or the negative electrode 14 of the rechargeable battery 10 may include metal such as iron, zinc, cadmium, or other metals and/or oxides or hydroxides of these or other metals, unless otherwise specified or made clear from the context. Further, it shall be generally understood that the negative electrode 102 of the electrochemical cell 100 and the negative electrode 14 of the rechargeable battery 10 have similar or identical features, unless otherwise indicated or made clear from the context and, for the sake of efficient description, these are not described separately for each negative electrode.

Having described certain aspects of the electrochemical cell 100 and the rechargeable battery 10, attention is now directed to the description of certain implementations of the current collectors 107 that may be used in the electrochemical cell 100 and/or in the rechargeable battery 10. As compared to solid sheets of material, these implementations of the current collectors 107 may facilitate efficient use of material used to form the current collectors 107, thus reducing cost and weight of the electrochemical cell while retaining conductor efficiency (conductance of a given current collector with perforations divided by conductance of a solid sheet of the same material with the same mass and material proportions).

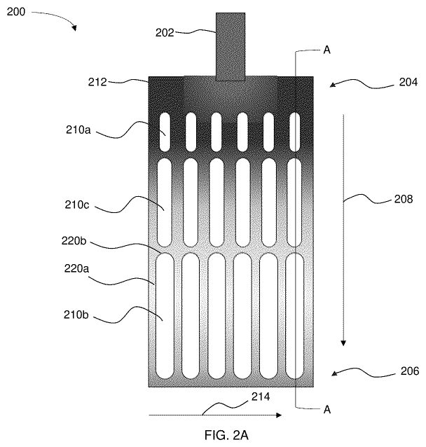

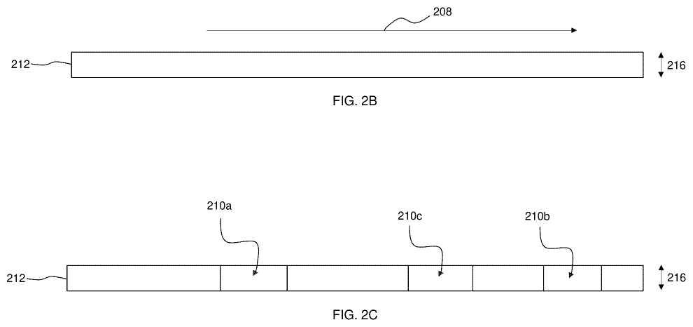

Referring now to FIGS. 2A-2C a current collector 200 for use in an electrochemical cell (e.g., the electrochemical cell 100 in FIG. 1A) may include a terminal 202 and a substrate 212. The substrate 212 may be made of an electrically conductive material. The substrate 212 may include a first end portion 204 and a second end portion 206, with the terminal 202 coupled to the first end portion 204 of the substrate such that the terminal 202 may be connected to external circuitry of an electrochemical cell. The substrate 212 may extend longitudinally from the first end portion 204 to the second end portion 206, defining a length in the longitudinal direction 208. The substrate 212 may have a span in a horizontal direction 214 perpendicular to the longitudinal direction 208 within a plane defined by the length and span of the substrate 212. Further, or instead, the substrate 212 may have a thickness 216 perpendicular to the plane defined by the length and span of the substrate 212, and the thickness 216 of the substrate 212 may be less than each of the length and span of the substrate 212 at any point along the substrate. This dimensional relationship between the length, span, and thickness of the substrate 212 may be useful, for example, so that the substrate 212 may use electrically conductive material efficiently while maintaining structural integrity.

The length of the substrate 212 may be a maximum dimension of the substrate 212, such that the length is greater than the span and the thickness of the substrate 212. In some implementations, the substrate 212 may have a first electrical conductivity parallel to the length of the substrate 212, the substrate 212 may have a second electrical conductivity parallel to the span of the substrate 212. Further, or instead, the first electrical conductivity may be greater than the second electrical conductivity such that electric current preferentially flows along the length of the substrate 212.

The substrate 212 may have a variation in cross-sectional area of the electrically conductive material along the length of the substrate. Specifically, the cross-sectional area of the electrically conductive material may decrease along at least a portion of the length in the longitudinal direction 208 from the first end portion 204 to the second end portion 206. This reduction in cross-sectional area of the electrically conductive material of the substrate 212 may correspond to the decreasing current density along the length of the substrate 212, thus reducing material usage in regions (away from the terminal 202) where current may move efficiently through lower conductivity. That is, the distribution of electrically conductive material may be varied along the substrate 212 of the current collector 200 to balance competing considerations of electrical performance (which benefits from more electrically conductive material) relative to weight reduction and cost efficiency (which benefit from less electrically conductive material).

In some implementations, decreasing cross-sectional area of electrically conductive material in the substrate 212 may be achieved through openings 210a,b,c (also referred to hereinafter referred to as a first set of openings 210a, a second set of openings 210b, and a third set of openings 210c) defined by the substrate 212 from the first end portion 204 to the second end portion 206 and extending through the thickness 216 of the substrate 212. In some implementations, the openings 210 extending through the thickness 216 of the substrate 212 may enhance ionic transport within an electrochemical cell by facilitating electrolyte penetration through the substrate 212. This may be especially useful in applications in which the current collector 200 is closely integrated with (e.g., embedded in) an active material of an electrode.

The openings 210a,b,c may be shaped, sized, and distributed to achieve economic material usage while maintaining efficient current conduction throughout the length of the substrate 212. By varying the size and shape of the openings 210 along the longitudinal direction 208, the structure of the substrate 212 may accommodate changing current density experienced by the current collector 200 in use in an electrochemical cell, with a greater amount (mass) of electrically conductive material toward the first end portion 204 (where the substrate 212 must accommodate higher current density for efficient current conduction) and less electrically conductive material toward the second end portion 206 (where efficient current conduction may be accommodated with less electrically conductive material).

For example, the first end portion 204 of the substrate 212 may define a first set of openings 210a and a second set of openings 210b. The first set of openings 210a may collectively have a first open area in a plane defined by the length and the span of the substrate 212. The second set of openings 210b may collectively have a second open area in the plane defined by the length and the span of the substrate 212. The second open area of the second set of openings 210b may be greater than the first open area of the first set of openings 210a, and at least a portion of one or more of the first set of openings 210a may be disposed between the first end portion 204 of the substrate and at least a portion of one or more of the second set of openings 210b in the longitudinal direction 208 from the terminal 202 to the second end portion 206. Stated differently, the open area in a spanwise direction along the substrate 212 increases progressively in the longitudinal direction 208 from the first end portion 204 to the second end portion 206, as is useful for using less electrically conductive material where current density is lower in the substrate 212 while using more electrically conductive material where current density is higher in the substrate 212 during use in an electrochemical cell-thus, accommodating current conduction requirements using less material than a solid sheet of a substrate.

In certain implementations, the first set of openings 210a and the second set of openings 210b may each be stadium-shaped. Further, or instead, the stadium shape of each of the second set of openings 210b may be wider and longer than the stadium shape of each of the first set of openings 210a such that the second set of openings 210b have a greater open area than that of the first set of openings 210a. This increase in open area reduces the cross-sectional area of electrically conductive material in regions where the current density is lower along the length of the substrate 212 of the current collector 200 in use in an electrochemical cell, contributing to material savings while maintaining adequate conductivity.

In certain implementations, the substrate 212 may define a third set of openings 210c collectively having a third open area greater than the first open area of the first set of openings 210a and less than the second open area of the second set of openings 210b. At least a portion of one or more of the third set of openings 210c may be disposed between at least a portion of one or more of the first set of openings 210a and at least a portion of one or more of the second set of openings 210b along the length of the substrate 212. That is, the third set of openings 210c may accommodate an intermediate amount of current density, between the higher current density along the first end portion 204 of the substrate and the lower current density along the second end portion 206 of the substrate.

In some implementations, the first set of openings 210a may be longitudinally spaced away from an edge of the substrate 212, leaving a region of the substrate 212 intact without perforations. This unperforated area along the first end portion 204 may provide continuous conductive section extends across the span of the substrate 212 at the first end portion 204. By maintaining a solid, uninterrupted cross-section in this region, the first end portion 204 have serve as a low-resistance path for current to flow toward the terminal 202 and further, or instead, may facilitate secure and reliable attachment of the terminal 202 to the first end portion 204. The spacing of the first set of openings 210a away from an edge of the substrate 212 along the first end portion 204 may also, or instead, be useful to preserve the structural integrity of the first end portion 204, increasing the likelihood that the current collector 200 may withstand mechanical stresses associated with connection of the current collector 200 and operation within the electrochemical cell.

In certain implementations, one or more instances of the openings 210 may have at least one straight edge 220a and at least one curved edge 220b. This combination of straight and curved edges may contribute to the structural integrity of the substrate 212 while meeting targets for variations in electrical properties of the substrate 212. In some examples, one or more instances of the openings 210 may be elongated, with a maximum dimension parallel to the longitudinal direction 208 defined from the first end portion 204 to the second end portion 206 of the substrate 212. This orientation may at least partially align with the primary current flow path along the substrate 212 in some implementations, facilitating efficient current transport while reducing electrical resistance. Continuing with this example, the elongated shape of the openings 210 may facilitate reducing material usage without significantly compromising the cross-section of electrically conductive material required to support the current density along the substrate 212. Further, or instead, the inclusion of at least one curved edge 220b of one or more instances of the openings 210 may distribute mechanical stress evenly across the substrate 212, with less likelihood of stress concentrations occurring during manufacturing, installation, and use. Still further, or instead, the at least one straight edge 220a may provide a well-defined boundary that may facilitate achieving the precision of the perforation process, for example, for uniformity in the pattern and consistency across the substrate 212.

While certain shapes of substrates have been described, it shall be appreciated that other shapes of substrates are additionally or alternatively possible for accommodating gradients in current density while making efficient use of electrically conductive material that may contribute to the cost and weight of an electrochemical cell.

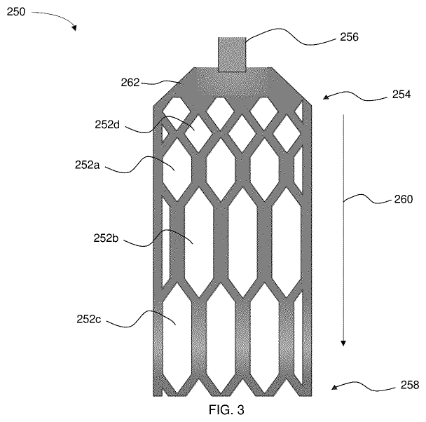

For example, referring now to FIG. 3, a current collector 250 for use in an electrochemical cell, may include a terminal 256 and a substrate 262. In general, the substrate 262 may include openings 252 (also referred to hereinafter as a first set of openings 252a, a second set of openings 252b, a third set of openings 252c, and a fourth set of openings 252d) having shapes formable through the application of one or more expansion forces to the substrate 262. That is, as described in greater detail below, the openings 252 may be formed by perforating the substrate 262 and applying a force to the substrate such that the perforations in the substrate 262 form the openings 252, with the resulting substrate 262 forming an expanded mesh. As compared to openings formed by removing material, it shall be appreciated that the openings 252 formed through perforation and the application of an expansion force result in less waste of material and, thus, an associated cost savings.

In general, the openings 252 may be arranged in a pattern that may facilitate efficient material distribution along the substrate 262 while accommodating variations in current density along the substrate 262. Thus, similar to the configuration discussed above with respect to FIG. 2A, the substrate 262 may extend from a first end portion 254 (where a terminal 256 is coupled to the substrate 262) to a second end portion 258 along a longitudinal direction 260.

The first set of openings 252a may be defined by the substrate 262 near the terminal 256. Compared to the second set of openings 252b and the third set of openings 252c, the first set of openings 252a may be relatively small, resulting in a higher cross-sectional area of electrically conductive material in this region of the substrate 262 where the current density is greatest in the current collector 250 in use in an electrochemical cell. This may provide structural integrity and electrical conductivity for efficient current transport to the terminal 256. Further along the substrate 262 in the longitudinal direction 260, the second set of openings 252b may be larger in both width and length compared to the openings of the first set of openings 252a. This increase in perforation size reduces the cross-sectional area of conductive material in regions with lower current density—away from the terminal 256—which may be useful in achieving a balance between efficient use of electrically conductive material and electrical performance. The second end portion 258 of the substrate 262 may define the third set of openings 252c having a larger collective open area than the second set of openings 252b. These larger openings reflect the low current density at this portion of the substrate 262 in use of the current collector 250, allowing for significant material reduction while maintaining adequate functionality.

In some implementations, the fourth set of openings 252d defined by the substrate 262 may be diamond-shaped. Such diamond shapes are formable with little or no waste of material through a combination of perforation and expansion force on the substrate 262. Further, or instead, diamond shapes may be useful for nesting openings close to one another in different patterns, including patterns in which a maximum dimension of the diamond shapes may be aligned with the longitudinal direction 260 and/or oblique to the longitudinal direction 260, as may be useful for tuning lengthwise and spanwise conductivity of the substrate 262, as described in greater detail below.

In some implementations, multiple perforation shapes may be used within a single substrate to address varying current density and structural needs along the length of the substrate. For example, the substrate may include hexagonal perforations near the terminal end to promote lengthwise conductivity where current density is highest, transitioning to square or diamond-shaped perforations in areas where balanced conductivity or enhanced mechanical integrity is desired. This combination of shapes may facilitate achieving targets for efficient material usage and electrical performance while maintaining sufficient mechanical strength across the substrate.

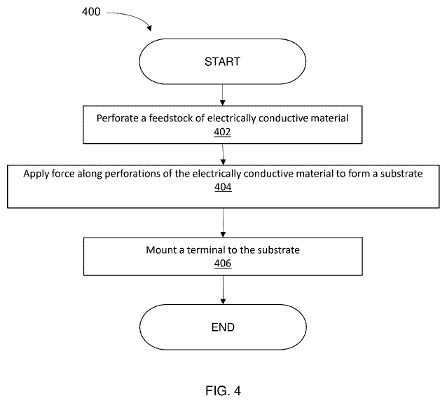

FIG. 4 is a flow chart of an exemplary method 400 for fabricating a current collector for an electrochemical cell. Unless otherwise specified or made clear from the context, it shall be appreciated that the exemplary method 400 may be used to produce a current collector including a substrate having the form of an expanded mesh (e.g., the current collector 250 including the substrate 262 in FIG. 3). As compared to the use of punching to remove material, the exemplary method 400 may reduce material was in the fabrication process while producing a current collector that makes efficient use of electrically conductive material while meeting current density requirements for the current collector.

As shown in step 402, the exemplary method 400 may include perforating a feedstock of electrically conductive material. The electrically conductive material may include one or more of copper, aluminum, or an alloy of these materials. In general, the electrically conductive material may provide efficient electrical conductivity while maintaining mechanical and electrochemical stability under the operating conditions of an electrochemical cell.

The perforations formed in the feedstock of the electrically conductive material may be formed in a predetermined pattern and extend through the thickness of the feedstock. Each perforation may be, for example, a slice in the feedstock and, thus, may be formed by any one or more cutting tools. As used in this context, a slice shall be understood to include a penetration having a length much longer than a width, and the width of the penetration is equal to the thickness of the cutting tool used to make the perforation. For example, a perforation may be made by penetrating the feedstock with a cutting head and, with the cutting head extending through the feedstock, moving the cutting head in a longitudinal direction along the feedstock. As may be appreciated from this example, perforations in the feedstock result in little loss of the electrically conductive material of the feedstock, which may be useful for both cost-effectiveness and lower carbon footprint of the current collector being fabricated.

The pattern of these perforations through the feedstock is related to the size and shape of the openings in the substrate formed by expansion of the perforated feedstock. designed based on the current density distribution along the length of the substrate. Thus, for example, shorter perforations may be made along portions of the feedstock that will ultimately become a portion of a substrate near the terminal while longer perforations may be made along portion of the feedstock that will ultimately become a portion of the substrate further away from the terminal.

As shown in step 404, the exemplary method 400 may include applying force along the perforations in the electrically conductive material. The force may be a compressive force, an expansion force, or a combination thereof such that the perforations in the electrically conductive material expand to form a substrate with openings from a first end portion of the substrate to a second end portion of the substrate. In particular, the openings in the substrate formed from applying force to the perforated feedstock may have an increasing open area in at least one direction along the substrate and, thus, the electrically conductive material may have decreasing cross-sectional area in the at least one direction along the substrate. For example, the electrically conductive material may have cross-sectional area decreasing along at least a portion of the substrate in a longitudinal direction from a first end portion to a second end portion of the substrate.

While uniform force may be applied to the feedstock to expand the perforations into openings, it shall be appreciated that different forces may be applied along the feedstock such that the perforations expand to different extents between the first end portion and the second portion. This may be useful for tuning the shapes and/or orientations of the openings along a primary direction of current flow in the current collector in use in an electrochemical cell.

As shown in step 406, the exemplary method 400 may include mounting a terminal to the first end portion of the substrate. Mounting the terminal to the substrate may be useful for establishing a secure electrical and mechanical connection between the current collector and the external electric circuit. The terminal serves as the interface for current flow out of the electrochemical cell, making its attachment a potentially significant determinant of performance of the current collector.

Mounting process may vary depending on the design and materials used for the terminal and for the substrate. Techniques for attaching the terminal to the substrate may include welding, soldering, or mechanical fastening, each of which provides a reliable connection. For instance, welding the terminal to the substrate may facilitate forming a low-resistance joint, resulting in low voltage drops at the connection point. Soldering may be used as an alternative for terminals requiring a more thermally or electrically conductive bond. Mechanical fastening, such as clamping or bolting, may also be employed for implementations that necessitate easy disassembly or maintenance.

While current collectors have been described as having patterns of openings for conductor efficiency in a direction parallel or perpendicular to an overall dimension of a substrate of the current collector, it shall be appreciated that other orientations of openings are additionally or alternatively possible. For example, in certain implementations, the direction of high conductivity in a current collector may be angled relative to the length and/or to the span of the substrate of the current collector. In such instances, savings of the electrically conductive material while maintaining high conductor efficiency may be achievable by forming a plurality of openings that are similarly angled relative to the length and/or to the span of the substrate of the current collector.

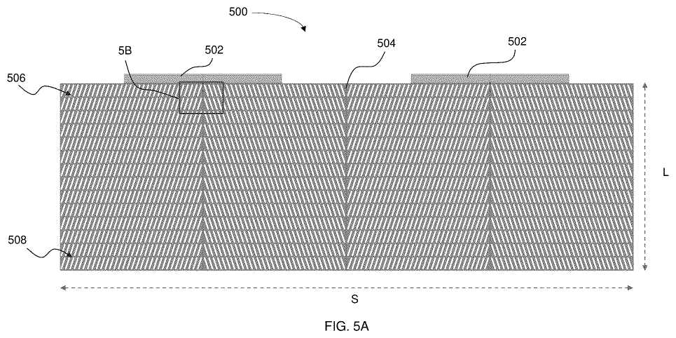

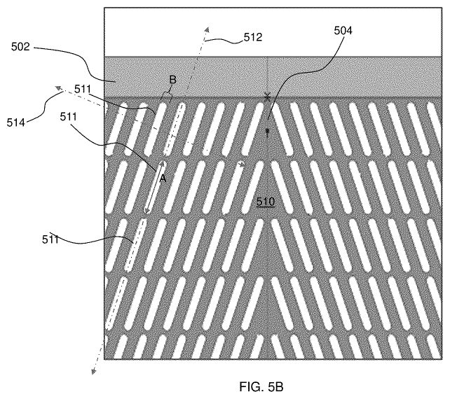

Referring now to FIGS. 5A and 5B, a current collector 500 may include a terminal 502 and a substrate 504. The terminal 502 may be electrically connectable to an external electric circuit and, unless otherwise specified or made clear from the context, shall be understood to be similar to any one or more other terminals described herein. Further, or instead, the substrate 504 may be an electrically conductive material, such as copper, aluminum, or other highly conductive material. The substrate 504 may have a first end portion 506 and a second end portion 508. The terminal 502 may be coupled to the first end portion 506. The first end portion 506 and the second end portion 508 may define a length L of the substrate 504 perpendicular to a thickness of the substrate 504. A span S of the substrate 504 may be perpendicular to each of the length L and to the thickness of the substrate 504, with the span S and the length L defining a plane of the substrate 504. As used here, it shall be understood that the length L of the substrate 504 and the span S of the substrate 504 refer to the overall maximum dimensions of the substrate 504 in a plane perpendicular to the thickness of the substrate 504.

In certain instances, a direction of high conductivity of the current collector may be angled relative to each of the span S and the length L of the substrate 504. That is, the direction of high conductivity of the current collector is neither along the length L nor the span S of the substrate 504. Thus, to facilitate achieving high conductor efficiency while making efficient use of material, the substrate 504 may define a plurality of non-circular openings 511 through the thickness of the substrate, with a shape of each non-circular opening 511 on a surface 510 of the substrate having a maximum dimension A defining a respective major axis 512, and the respective major axis 512 of each non-circular opening 511 oblique to the length L of the substrate 504. That is, the plurality of non-circular openings 511 such that the respective maximum dimension A of each non-circular opening 511 is angled to match or substantially match the direction of high conductivity through the current collector 500 in the electrochemical cell. In certain implementations, each non-circular opening 511 may have a minimum dimension B defining a respective minor axis 514. The minimum dimension B may be less than the major dimension A, and the minor axis 514 of each non-circular opening 511 may be oblique to the length L of the substrate 504, and thus also oblique to the span S of the substrate 504. As an example, the substrate 504 may have an average thickness greater than 0.35 mm and less than 0.55 mm (e.g., 0.45 mm) to facilitate achieving high conductor efficiency while using an efficient amount of electrically conductive material. Further, or instead, the plurality of non-circular openings 511 may, collectively, have a total open area that is 40 percent of a total overall area of the substrate 504. As used in this context, the total overall area of the substrate 504 shall be understood to be the total area of the surface 510 of the substrate 504, calculated as the product of the length L and the span S of the substrate 504 in instances in which the substrate 504 has an overall rectangular shape.

While current collectors have been described as having openings as a way to balance the use of electrically conductive material relative to conduction efficiency, it shall be appreciated that other approaches are additionally or alternatively possible.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the described embodiment. Further, any step of any embodiment described herein can be used in any other embodiment. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the following claims and the principles and novel features disclosed herein.

What is claimed is:

1. A current collector for an electrochemical cell, the current collector comprising:
a terminal electrically connectable to an external electric circuit; and
a substrate including an electrically conductive material and having a first end portion and a second end portion, the terminal disposed on the first end portion, the substrate having a length from the first end portion to the second end portion, and the electrically conductive material having cross-sectional area decreasing along at least a portion of the length in a longitudinal direction from the terminal to the second end portion of the substrate.

2. The current collector of claim 1, wherein the substrate has a span and a thickness perpendicular to one another and each perpendicular to the length, and the thickness is less than each of the length and the span at any point along the substrate.

3. The current collector of claim 2, wherein the substrate has a first electrical conductivity parallel to the length of the substrate, the substrate has a second electrical conductivity parallel to the span of the substrate, and the first electrical conductivity is greater than the second electrical conductivity.

4. The current collector of claim 2, wherein the span of the substrate varies in the longitudinal direction from the terminal to the second end portion of the substrate.

5. The current collector of claim 2, wherein the length is a maximum dimension of the substrate.

6. The current collector of claim 2, wherein the substrate defines a plurality of openings through the thickness of the substrate.

7. The current collector of claim 6, wherein the substrate is a sheet.

8. The current collector of claim 6, wherein one or more of the plurality of openings has a maximum dimension parallel to the length of the substrate.

9. The current collector of claim 6, wherein one or more of the plurality of openings has at least one straight edge.

10. The current collector of claim 6, wherein one or more of the plurality of openings has at least one curved edge.

11. The current collector of claim 6, wherein the plurality of openings includes a first set of openings and a second set of openings, the first set of openings collectively having a first open area in a plane defined by the length and the span of the substrate, the second set of openings collectively having a second open area in the plane defined by the length and the span of the substrate, the second open area is greater than the first open area, and at least a portion of one or more of the first set of openings is disposed between the first end portion and at least a portion of one or more of the second set of openings in the longitudinal direction from the terminal to the second end portion.

12. The current collector of claim 11, wherein the first set of openings include at least one elongated hexagon in a plane defined by the length and the span of the substrate.

13. The current collector of claim 11, wherein at least one of the first set of openings has a first width parallel to the span of the substrate, at least one of the second set of openings has a second width parallel to the span of the substrate, and the second width is greater than the first width.

14. The current collector of claim 11, wherein at least one of the first set of openings has a first length dimension parallel to the length of the substrate, at least one of the second set of openings has a second length dimension parallel to the length of the substrate, and the second length dimension is greater than the first length dimension.

15. The current collector of claim 11, wherein the plurality of openings includes a third set of openings collectively having a third open area greater than the first open area and less than the second open area, and at least a portion of one or more of the third set of openings is disposed between at least a portion of one or more of the first set of openings and at least a portion of one or more of the second set of openings along the length of the substrate.

16. A method of fabricating a current collector for an electrochemical cell, the method comprising:
perforating a feedstock of electrically conductive material;
applying force along perforations of the electrically conductive material, the force forming a substrate of the electrically conductive material with the substrate expanding the perforations into a plurality of openings from a first end portion of the substrate to a second end portion of the substrate, and the electrically conductive material having cross-sectional area decreasing along at least a portion of the substrate in a longitudinal direction from the first end portion to the second end portion of the substrate; and
mounting a terminal to the first end portion of the substrate.

17. A current collector for an electrochemical cell, the current collector comprising:
a terminal electrically connectable to an external electric circuit; and
a substrate of an electrically conductive material, the substrate having a first end portion and a second end portion, the terminal coupled to the first end portion, the first end portion and the second end portion defining a length of the substrate perpendicular to a thickness of the substrate, the substrate defining a plurality of non-circular openings through the thickness, a shape of each non-circular opening on a surface of the substrate having a maximum dimension defining a respective major axis, and the respective major axis of each non-circular opening oblique to the length of the substrate.

18. The current collector of claim 17, wherein each non-circular opening has a minimum dimension defining a respective minor axis, the minimum dimension is less than the major dimension, and the respective minor axis of each non-circular opening is oblique to the length of the substrate.

19. The current collector of claim 17, wherein the substrate has an average thickness greater than 0.35 mm and less than 0.55 mm.

20. The current collector of claim 17, wherein, collectively, the plurality of non-circular openings have a total open area that is 40 percent of a total overall area of the substrate.
